(19) United States
(12) Patent Application Publication
(10) Pub. No.: US 2019/0107335 A1
(43) Pub. Date: Apr. 11, 2019

(54) HEAT STORAGE LAMINATE

(71) Applicant: DIC Corporation, Tokyo (JP)

(72) Inventors: Kenichi Fujisaki, Saitama (JP); Yuko Koseki, Saitama (JP); Tomoyuki Furukawa, Saitama (JP)

(73) Assignee: DIC Corporation, Tokyo (JP)

(21) Appl. No.: 16/213,363

(22) Filed: Dec. 7, 2018

Related U.S. Application Data
(63) Continuation of application No. PCT/JP2017/021285, filed on Jun. 8, 2017.

(30) Foreign Application Priority Data
Jun. 22, 2016 (JP) 2016-123545

(51) Int. Cl. F28D 20/02; B32B 13/12; B32B 13/08; B32B 7/12

(52) U.S. Cl. CPC F28D 20/023; B32B 13/12; F28D 2020/0008; B32B 7/12; B32B 13/08

(57) ABSTRACT

A heat storage laminate includes an inorganic substrate and an organic heat storage layer, wherein the inorganic substrate and the organic heat storage layer are laminated to one another. The inorganic substrate has a thickness of 8 mm or more and a mass reduction ratio of 4% by mass or more, as measured when the inorganic substrate is held at a temperature of 105° C. until a constant mass is obtained.

### TECHNICAL FIELD

One or more embodiments of the present invention relate to a heat storage laminate which is capable of maintaining an appropriate temperature and saving energy according to various modes of the use of the laminate. Particularly, one or more embodiments of the present invention are concerned with a heat storage laminate having excellent flame retardancy such that the laminate advantageously maintains an appropriate temperature for housing spaces of houses and the like and interior spaces of automobiles and the like.

### BACKGROUND

Recently, strong demands are being made on housing spaces of houses, offices, and the like wherein energy should be saved, and, in the building materials used in houses and the like, materials that contribute to energy savings are demanded. Generally, heat insulating materials are used in floors, ceilings, walls and the like in an attempt to improve the air-conditioning or heating efficiency, and, for further saving energy, studies are made on various types of materials. Similarly, with respect to closed spaces of automobiles, aircraft and the like, and the inside of refrigerators of refrigerator trucks and the like, demands for saving energy are increasing.

With respect to the above-mentioned materials, for example, a material having an encapsuled phase change material mixed into plasterboard is disclosed (see PTL 1). Further, as a material using a flexible material, a heat-storage thermoplastic resin sheet containing a heat storage material in a thermoplastic resin (see PTL 2) and the like are disclosed.

PTL 1: JP-A-2003-284939

PTL 2: JP-A-2009-51016

The above-mentioned material having a phase change material mixed into plasterboard is used in walls or the like so as to increase the heat capacity of the walls or the like, achieving energy savings. However, this material is poor in flexibility or handling properties, and hence the mode of the use of the material is limited. Further, the material having a phase change material mixed into plasterboard is disadvantageous in that the phase change material leaks at high temperatures to generate a combustible gas, causing the flame retardancy to be poor.

The above-mentioned sheet using a thermoplastic resin has flexibility due to the use of the thermoplastic resin. However, upon being in contact with a flame, it is difficult for the sheet to achieve flame retardancy.

### SUMMARY

One or more embodiments of the present invention provide a heat storage laminate having heat storage properties that can contribute to maintaining an appropriate temperature according to the mode of the use thereof, and having excellent flame retardancy.

One or more embodiments of the present invention are directed to a heat storage laminate including an inorganic substrate and an organic heat storage layer which are laminated on one another, wherein the inorganic substrate has a thickness of 8 mm or more and has a mass reduction ratio of 4% by mass or more as measured when the inorganic substrate is allowed to have a constant mass at a temperature of 105° C.

In the heat storage laminate of one or more embodiments of the present invention, as the inorganic substrate to be laminated on the heat storage layer, an inorganic substrate having a predetermined water content or more is used, and therefore, despite using a heat storage layer mainly made of an organic material as the heat storage layer, excellent flame retardancy can be achieved.

The above-mentioned heat storage formed article of one or more embodiments of the present invention can be used in various applications, and can advantageously contribute to energy savings in various applications, such as materials applied to wall materials and wall paper for housing spaces of houses and the like, interior spaces of automobiles, electric trains, aircraft, agricultural hothouses and the like, closed spaces, e.g., the inside of refrigerators of refrigerator trucks and refrigeration equipment, and the inside of aircraft, and electric parts which generate heat, e.g., a CPU and a storage battery for personal computer.

### DETAILED DESCRIPTION OF THE EMBODIMENTS

The heat storage laminate of one or more embodiments of the present invention is a heat storage laminate including an inorganic substrate and an organic heat storage layer which are laminated on one another, wherein the inorganic substrate has a thickness of 8 mm or more and has a mass reduction ratio of 4% by mass or more as measured when the inorganic substrate is allowed to have a constant mass at a temperature of 105° C.

### [Inorganic Substrate]

The inorganic substrate used in the heat storage laminate of one or more embodiments of the present invention is an inorganic substrate having a mass reduction ratio of 4% by mass or more as measured when the inorganic substrate is allowed to have a constant mass at a temperature of 105° C. The mass reduction ratio is an index corresponding to the water content (including water of crystallization) of the inorganic substrate. The mass reduction ratio is more preferably 8% by mass or more, further preferably 10% by mass or more, especially preferably 15% by mass or more. When the mass reduction ratio is in the above range, the inorganic substrate dissociates water instantly upon being in contact with a flame to suppress an increase of the temperature of the laminate, making it possible to achieve advantageous flame retardancy. With respect to the upper limit of the mass reduction ratio, there is no particular limitation as long as the strength and stiffness of the inorganic substrate can be surely obtained, but the mass reduction ratio is preferably about 30% by mass or less. With respect to the inorganic substrate used in one or more embodiments, it is preferred to use the inorganic substrate which contains water, and, when the inorganic substrate is placed in an environment at a temperature of 23° C. and at a humidity of 50% so as to have a constant mass, it is possible to obtain the inorganic substrate which advantageously contains water.

The mass reduction ratio can be measured in accordance with the drying loss method of JIS K-0068, and, when a mass of a specimen before being dried is taken as wi, and a mass of the specimen which is dried by heating at a temperature of 105° C. so as to have a constant mass is taken as w₂, the mass reduction ratio is a value represented by [(w₁−w₂)/w₁]×100 (%).

In one or more embodiments of the present invention, the inorganic substrate has a thickness of 8 mm or more, and therefore advantageous flame retardancy can be achieved. The thickness of the inorganic substrate is more preferably 9.5 mm or more, especially preferably 12 mm or more. When the thickness of the inorganic substrate is in the above range, the amount of water contained in the inorganic substrate is readily secured, and it is easy to suppress thermal conduction of the laminate upon being in contact with a flame, making it possible to achieve excellent flame retardancy. With respect to the upper limit of the thickness, there is no particular limitation, but, from the viewpoint of handling properties, such as the weight or processing, the thickness is preferably 30 mm or less, more preferably 25 mm or less, especially preferably 20 mm or less.

The inorganic substrate of one or more embodiments preferably has a water vapor permeability (water vapor permeation coefficient per unit thickness) of 100 ng/m·s·Pa or less, more preferably 60 ng/m·s·Pa or less, further preferably 50 ng/m·s·Pa or less. When the air permeability is in the above range, it is easy to suppress permeation of a combustible gas through the inorganic substrate, facilitating achievement of advantageous flame retardancy of the laminate upon being in contact with a flame.

The water vapor permeability (μ) can be measured in accordance with JIS A1324 Cup method, and, with respect to a water vapor permeable cup having a moisture absorbent contained therein and having a specimen attached thereto, an increase or decrease in weight of the cup per unit time in an environment at 23° C. at 50% is taken as a water vapor permeation amount (G) of the specimen, and the water vapor permeability can be determined from the following formulae.

Zp=[(P1−P2)×A]/G

Wp=1/Zp

μ=Wp×d

Wp: water vapor permeation coefficient; Zp: water vapor permeation resistance; A: water vapor permeation area; P1: water vapor pressure of air in the thermo-hygrostat apparatus; P2: water vapor pressure of air in the water vapor permeable cup; μ: water vapor permeability; d: thickness of the specimen.

The inorganic substrate of one or more embodiments preferably has a thermal conductivity of 3 W/m·K or less, more preferably 1 W/m·K or less, further preferably 0.3 W/m·K or less. When the thermal conductivity of the inorganic substrate is in the above range, it is easy to suppress thermal conduction of the laminate upon being in contact with a flame, facilitating achievement of advantageous flame retardancy.

The thermal conductivity (λ) can be measured in accordance with JIS A1412-2, and a specimen, a heat flowmeter, a hot plate, and a cooling plate are stacked, and a predetermined temperature difference is given to the stack, and the thermal conductivity can be determined from the following formula.

λ=[(f×e)×d/ΔT]

λ: thermal conductivity; f: sensitivity factor of the heat flowmeter; e: power of the heat flowmeter; d: thickness of the specimen; ΔT: temperature difference of the specimen.

With respect to the type of the inorganic substrate, there is no particular limitation as long as the inorganic substrate has the above-mentioned water content, and examples of the inorganic substrates include plasterboard, a calcium silicate board, a flexible board, a cement board, and fiber-reinforced boards thereof. Of these, one containing water of crystallization having a decomposition temperature of 200° C. or lower can be preferably used, and plasterboard can be especially preferably used because it can easily retain water of crystallization to have a water content in the above range. As the plasterboard, plasterboard made of gypsum dihydrate is preferred.

With respect to the water vapor permeability and thermal conductivity of these inorganic substrates, plasterboard has a water vapor permeability of about 40 ng/m·s·Pa and a thermal conductivity of about 0.22 W/m·K, and a calcium silicate board has a water vapor permeability of about 52 ng/m·s·Pa and a thermal conductivity of about 0.18 W/m·K. Further, the fiber-reinforced cement board used in the below-mentioned Examples has a water vapor permeability of about 3.4 ng/m·s·Pa and a thermal conductivity of about 0.18 W/m·K.

### [Organic Heat Storage Layer]

The organic heat storage layer used in one or more embodiments of the present invention is a heat storage layer containing an organic material as a main component. As the heat storage layer, a heat storage layer having a heat storage material dispersed in a resin matrix can be preferably used. The organic heat storage layer is advantageous in that desired properties are readily obtained by controlling the formulation of the layer, and in that the formation of the layer or stacking of another material on the layer is relatively easy, but the organic heat storage layer contains an organic material as a main component and therefore is likely to be poor in flame retardancy. In one or more embodiments of the present invention, by using the above-mentioned inorganic substrate, both the excellent properties of the organic heat storage layer and advantageous flame retardancy can be achieved.

### (Matrix Resin)

With respect to the resin used in the resin matrix of one or more embodiments, various types of resins, such as thermoplastic resins, thermosetting resins, and ultraviolet curing resins, can be used. Especially, thermoplastic resins can be preferably used from the viewpoint of facilitating the formation of a coating film. Examples of thermoplastic resins include a vinyl chloride resin, an acrylic resin, a urethane resin, an olefin resin, an ethylene-vinyl acetate copolymer, a styrene-butadiene resin, a polystyrene resin, a polybutadiene resin, a polyester resin, a polyamide resin, a polyimide resin, a polycarbonate resin, a 1,2-polybutadiene resin, a polycarbonate resin, and a polyimide resin. Of these, a vinyl chloride resin is preferably used because formability at low temperatures and dispersibility of the heat storage material are readily obtained.

When a vinyl chloride resin is used in one or more embodiments, it is preferred that a sol cast film is formed using a vinyl sol coating liquid using vinyl chloride resin particles because the heat storage formed article can be formed at low temperatures. The vinyl sol coating liquid is a coating liquid in a paste state, which has a heat storage material dispersed or suspended in a resin composition containing vinyl chloride resin particles and a plasticizer.

The vinyl chloride resin particles of one or more embodiments preferably have an average particle diameter of 0.01 to 10 μm, preferably 0.1 to 5 μm. In the coating liquid, the vinyl chloride resin particles may be in a state in which the particles are directly dispersed in the coating liquid, or may be in a state in which the particles as primary particles suffer aggregation to form spherical secondary particles and the secondary particles are dispersed in the coating liquid. Alternatively, the vinyl chloride resin particles may be a mixture of particles having different particle diameters and having two or more peaks of the particle size distribution. The particle diameter can be measured by a laser method or the like.

The shape of the vinyl chloride resin particles used in the vinyl sol coating liquid of one or more embodiments is preferably a substantially spherical shape because advantageous fluidity is readily obtained and a change of the aged viscosity is small. With respect to the vinyl chloride resin particles, those which are produced by emulsion polymerization or suspension polymerization are preferred because the particles of a spherical shape can be easily obtained and it is easy to control the particle size distribution of the particles.

In one or more embodiments, the degree of polymerization of the vinyl chloride resin used is preferably 500 to 4,000, more preferably 600 to 2,000.

With respect to the vinyl chloride resin particles used in one or more embodiments of the present invention, commercially available vinyl chloride resin particles can be appropriately used, and, for example, there can be mentioned ZEST PQ83, PWLT, PQ92, P24Z, and the like, manufactured by Shin Dai-ichi Vinyl Corporation, and PSL-675, 685, and the like, manufactured by Kaneka Corporation.

When a thermoplastic resin is used as the resin for the organic heat storage layer of one or more embodiments, the thermoplastic resin content is preferably 10 to 80% by mass, more preferably 20 to 70% by mass, further preferably 30 to 60% by mass. When the thermoplastic resin content is in the above range, a sheet having flexibility is readily formed.

### (Plasticizer)

When a thermoplastic resin is used as the resin used in the organic heat storage layer of one or more embodiments, from the viewpoint of easily securing excellent application properties and film forming properties, it is preferred to use a plasticizer and the thermoplastic resin in combination. With respect to the plasticizer, an epoxy plasticizer, a methacrylate plasticizer, a polyester plasticizer, a polyether ester plasticizer, an aliphatic diester plasticizer, a trimellitic acid plasticizer, an adipic acid plasticizer, a benzoic acid plasticizer, a phthalic acid plasticizer, or the like can be appropriately used. Two or more types of plasticizers may be used appropriately in combination. When used in the application of building materials for houses and the like and the application of automobiles and the like, it is preferred to use a non-phthalic acid plasticizer other than the phthalic acidplasticizers which could adversely affect a human body.

With respect to the plasticizer of one or more embodiments, various types of plasticizers which are commercially available can be appropriately used, and examples of epoxy plasticizers include Monocizer W-150, manufactured by DIC Corporation; SANSO CIZER E-PS, E-PO, E-4030, E-6000, E-2000H, E-9000H, manufactured by New Japan Chemical Co., Ltd.; ADK CIZER O-130P, O-180A, D-32, D-55, manufactured by ADEKA Corporation; and KAPDX S-6, manufactured by Kao Corporation, examples of polyester plasticizers include Polycizer W-2050, W-2310, W-230H, manufactured by DIC Corporation; ADK CIZER PN-7160, PN-160, PN-9302, PN-150, PN-170, PN-230, PN-7230, PN-1010, manufactured by ADEKACorporation; D620, D621, D623, D643, D645, D620N, manufactured by Mitsubishi Chemical Corporation; and HA-5, manufactured by Kao Corporation, examples of trimellitic acid plasticizers include Monocizer W-705, manufactured by DIC Corporation; ADK CIZER C-9N, manufactured by ADEKA Corporation; and TOTM, TOTM-NB, manufactured by Mitsubishi Chemical Corporation, and examples of benzoic acid plasticizers include Monocizer PB-3A, manufactured by DIC Corporation; and JP120, manufactured by Mitsubishi Chemical Corporation.

In one or more embodiments of the present invention, among the above-mentioned plasticizers, a plasticizer capable of being gelled at low temperatures can be especially preferably used because it is easy to prevent the heat storage material or plasticizer from oozing. The plasticizer preferably has a gelation end-point temperature of 150° C. or lower, more preferably 140° C. or lower, further preferably 130° C. or lower, further preferably 120° C. or lower, especially preferably 110° C. or lower. With respect to the gelation end-point temperature, a temperature at which the light transmission properties of the gelled film become constant can be determined as a gelation end-point temperature. As the plasticizer having excellent low-temperature formability, an epoxy plasticizer, a polyester plasticizer, and a benzoic acid plasticizer can be preferably used. From the viewpoint of the heat resistance and the low-temperature formability, an epoxy plasticizer and a polyester plasticizer can be especially preferably used.

The gelation end-point temperature is specifically determined as follows. A composition having a vinyl chloride resin for paste (degree of polymerization: 1,700), the plasticizer, and a heat stabilizer (Ca—Zn) mixed in a mass ratio of 100/80/1.5 is placed between a glass plate and a prepared slide, and the temperature is increased at a temperature increase rate of 5° C./min, and a change of the light transmission properties is observed using a hot stage for microscopic examination (Metter 800), and a temperature at which the light transmission properties of the composition become constant is determined as a gelation end-point temperature.

The plasticizer used in one or more embodiments of the present invention preferably has a viscosity at 25° C. of 1,500 mPa·s or less, more preferably 1,000 mPa·s or less, further preferably 500 mPa·s or less, especially preferably 300 mPa·s or less. When the viscosity of the plasticizer is in the above range, the viscosity of the vinyl sol coating liquid can be suppressed to be low, making it possible to increase the filling ratio of the heat storage material. With respect to the conditions for the plasticizer viscosity measurement, the measurement can be made under the conditions employed in the below-mentioned Examples.

The plasticizer used in one or more embodiments of the present invention preferably has a weight average molecular weight of 200 to 3,000, more preferably 300 to 1,000. When the weight average molecular weight of the plasticizer is in the above range, the plasticizer per se is unlikely to ooze out of the sheet and the viscosity of the vinyl sol coating liquid can be suppressed to be low, making it possible to increase the filling ratio of the heat storage material. The weight average molecular weight (Mw) is a value measured by gel permeation chromatography (hereinafter, abbreviated to “GPC”) using a calibration curve obtained with respect to polystyrene. The GPC measurement can be conducted under the conditions shown below.

### <Conditions for Measurement of a Weight Average Molecular Weight>

Measuring apparatus: Guard column “HLC-8330”, manufactured by Tosoh Corp.
Columns: “TSK SuperH-H”, manufactured by Tosoh Corp.

+“TSK gel SuperHZM-M”, manufactured by Tosoh Corp.

+“TSK gel SuperHZM-M”, manufactured by Tosoh Corp.

+“TSK gel SuperHZ-2000”, manufactured by Tosoh Corp.

+“TSK gel SuperHZ-2000”, manufactured by Tosoh Corp.
Detector: RI (Differential refractometer)
Data processing: “GPC-8020 Model II Version 4.10”, manufactured by Tosoh Corp.
Column temperature: 40° C.
Developing solvent: Tetrahydrofuran (THF)
Flow rate: 0.35 mL/minute
Sample: A 1.0% by mass tetrahydrofuran solution, in terms of a resin solids content, which has been subjected to filtration using a microfilter (100 μ1)
Standard sample: In accordance with the measurement manual of the above-mentioned “GPC-8020 Model II Version 4.10”, the monomodal polystyrenes having known molecular weights shown below were used.

### <Standard Sample: Monomodal Polystyrenes>

“A-300”, manufactured by Tosoh Corp.

“A-500”, manufactured by Tosoh Corp.

“A-1000”, manufactured by Tosoh Corp.

“A-2500”, manufactured by Tosoh Corp.

“A-5000”, manufactured by Tosoh Corp.

“F-1”, manufactured by Tosoh Corp.

“F-2”, manufactured by Tosoh Corp.

“F-4”, manufactured by Tosoh Corp.

“F-10”, manufactured by Tosoh Corp.

“F-20”, manufactured by Tosoh Corp.

“F-40”, manufactured by Tosoh Corp.

“F-80”, manufactured by Tosoh Corp.

“F-128”, manufactured by Tosoh Corp.

“F-288”, manufactured by Tosoh Corp.

When the heat storage material used in one or more embodiments of the present invention is a heat storage material in the form of microcapsules containing a heat storage material in a resin outer shell, among the above plasticizers, it is preferred to use a plasticizer such that an HSP distance between the heat storage material used and the plasticizer is 6 or more. By using the plasticizer, elimination of an eliminating component from the heat storage formed article at high temperatures can be suppressed, facilitating achievement of advantageous heat resistance such that volume shrinkage is unlikely to occur even at high temperatures. In a formed article comprising a resin composition containing a general thermoplastic resin and a plasticizer and containing no heat storage material, large volume shrinkage is unlikely to occur even at high temperatures. However, in a heat storage formed article containing a heat storage material, large volume shrinkage likely occurs at high temperatures. In one or more embodiments of the present invention, when the HSP distance between the heat storage material and the plasticizer is in the above range, incorporation of the plasticizer, which causes an eliminating component in a large amount at high temperatures, into the heat storage material is suppressed, so that the occurrence of volume shrinkage at high temperatures is more likely to be suppressed, facilitating achievement of advantageous heat resistance. From the viewpoint of easily obtaining advantageous heat resistance, the HSP distance is preferably 7 or more, more preferably 8 or more. With respect to the upper limit of the HSP distance, there is no particular limitation as long as the plasticizer is generally used as a plasticizer, but, from the viewpoint of easily obtaining advantageous compatibility and formability, the HSP distance is preferably 40 or less, more preferably 30 or less, further preferably 25 or less.

The HSP distance is an index indicating the solubility between substances using a Hansen solubility parameter (HSP). The Hansen solubility parameter indicates solubility using a multi-dimensional (typically three-dimensional) vector, and the vector can be represented using a dispersion term, a polar term, and a hydrogen bond term. The degree of similarity of the vector is indicated by a distance between the Hansen solubility parameters (HSP distance).

With respect to the Hansen solubility parameter of one or more embodiments, values for reference are shown in various documents, and, for example, there can be mentioned Hansen Solubility Parameters: A User's Handbook (Charles Hansen et. al., 2007, the 2nd edition) and the like. Alternatively, using commercially available software, for example, using Hansen Solubility Parameter in Practice (HSPiP), a Hansen solubility parameter can be determined based on the chemical structure of a substance. The determination is made for a solvent temperature of 25° C.

With respect to a preferred combination of the plasticizer and the heat storage material, for example, when the heat storage material having an acrylic outer shell is used, an epoxy plasticizer, a polyester plasticizer, a trimellitic acid plasticizer, or the like can be preferably used. When the heat storage material having a melamine outer shell is used, an epoxy plasticizer, a polyester plasticizer, a trimellitic acid plasticizer, a benzoic acid plasticizer, or the like can be preferably used. Especially an epoxy plasticizer is preferred because various properties, such as a heat resistance, can be advantageously obtained.

Further, in one or more embodiments of the present invention, from the viewpoint of advantageously constituting the resin matrix of a formed article, the HSP distance between the thermoplastic resin and the plasticizer used is preferably 15 or less, more preferably 12 or less. The lower limit of the HSP distance is not particularly limited, but is preferably 1 or more, more preferably 2 or more, further preferably 3 or more.

When the heat storage material in the form of microcapsules containing a heat storage material in a resin outer shell is used in one or more embodiments, there can be preferably used a plasticizer such that, when the plasticizer is mixed into the heat storage material used, an absorption of the plasticizer into 100 parts by mass of the heat storage material is 150 parts by mass or less, as measured in accordance with JIS K5101-13-1. By using the plasticizer, elimination of an eliminating component from the heat storage formed article at high temperatures can be suppressed, enabling achievement of advantageous heat resistance such that volume shrinkage is unlikely to occur even at high temperatures. From the viewpoint of readily obtaining advantageous heat resistance, the absorption of the plasticizer is preferably 140 parts by mass or less, more preferably 135 parts by mass or less, further preferably 130 parts by mass or less. With respect to the lower limit of the absorption of the plasticizer, there is no particular limitation as long as the plasticizer is generally used as a plasticizer, but, from the viewpoint of easily obtaining advantageous compatibility and formability, the absorption of the plasticizer is preferably 5 or more, more preferably 10 or more.

The absorption of the plasticizer is measured by the method for measuring an oil absorption in accordance with JIS K5101-13-1. Specifically, a sample obtained by weighing 1 to 20 g of a heat storage material according to the expected absorption is placed on a glass plate, and a plasticizer is dropwise added to the sample from a burette so that 4 to 5 droplets of the plasticizer are added at a time. After each addition, the plasticizer is kneaded into the sample using a palette knife made of steel. This is repeated and the dropwise addition of the plasticizer is continued until a solid mass of the plasticizer and sample is formed. Thereafter, one droplet of the plasticizer is added at a time and completely kneaded into the mass, and this is repeated, and a point in time when the mass has become a smooth paste is determined as an end point, and the absorption at the end point is taken as an absorption of the plasticizer. The paste is such smooth that the paste can be spread without being cracked or crumbling into small pieces and lightly adheres to a measuring plate.

The content of the plasticizer in the organic heat storage layer of one or more embodiments is preferably 5 to 75% by mass, more preferably 10 to 70% by mass, further preferably 20 to 60% by mass. When the plasticizer content is in the above range, excellent application properties and formability can be readily obtained. With respect to the proportion of the contained plasticizer to the thermoplastic resin, the amount of the plasticizer, relative to 100 parts by mass of the thermoplastic resin, is preferably 30 to 150 parts by mass, more preferably 30 to 120 parts by mass, further preferably 40 to 100 parts by mass.

### (Heat Storage Material)

With respect to the heat storage material of one or more embodiments, there is no particular limitation as long as it has heat storage properties, and there can be used a heat storage material of a latent heat type, a heat storage material of a sensible heat type, and a heat storage material of a chemical reaction type utilizing absorption of heat or generation of heat caused due to a chemical reaction. Of these, a heat storage material of a latent heat type is preferred because the material with a small volume readily secures a large amount of energy, and it is easy to control the heat absorption or radiation temperature of the material.

With respect to the heat storage material of a latent heat type (phase change material) of one or more embodiments, taking into consideration the potential oozing of the material during melting due to a phase change and the like and the dispersibility of the material upon mixing, preferred are heat storage particles in the form of capsules having a phase change material, such as a paraffin, contained in an outer shell made of an organic material or the like. In one or more embodiments of the present invention, when the heat storage particles having an outer shell are used, the HSP distance is calculated based on the HSP of the material used in the outer shell of the heat storage particles. In the heat storage formed article of one or more embodiments of the present invention, even when the heat storage material containing a phase change material, such as a paraffin, in an outer shell made of an organic material is used, the outer shell is unlikely to suffer embrittlement due to a plasticizer, so that the heat storage material is unlikely to be damaged.

With respect to the heat storage particles of one or more embodiments, examples of those using an outer shell made of a melamine resin include Thermo Memory FP-16, FP-25, FP-27, FP-31, FP-39, manufactured by Mitsubishi Paper Mills Limited, and RIKEN-RESIN PMCD-15SP, 25SP, 32SP, manufactured by Mikiriken Industrial Co., Ltd. Examples of heat storage particles using an outer shell made of silica include RIKEN-RESIN LA-15, LA-25, LA-32, manufactured by Mikiriken Industrial Co., Ltd., and examples of heat storage particles using an outer shell made of a polymethyl methacrylate resin include Micronal DS5001X, 5040X, manufactured by BASF AG.

With respect to the particle diameter of the heat storage particles of one or more embodiments, there is no particular limitation, but the particle diameter is preferably about 10 to 1,000 μm, more preferably 50 to 500 μm. With respect to the particle diameter of the heat storage particles, it is preferred that the particle diameter of the primary particles is in the above range, but it is also preferred that the heat storage particles having a primary particle diameter of 1 to 50 μm, preferably 2 to 10 μm suffer aggregation to form secondary particles, and the particle diameter of the secondary particles is in the above range. Such heat storage particles are easily damaged due to a pressure or a shear, but, by virtue of having the construction in one or more embodiments of the present invention, a damage of the heat storage particles can be advantageously suppressed, so that oozing or leakage of the heat storage material from the particles is unlikely to occur. Especially when the outer shell is formed from an organic material, there is a fear that the particles are damaged due to temperatures. However, the heat storage formed article of one or more embodiments of the present invention is advantageous in that even when using the phase change material having such an outer shell, oozing or leakage of the heat storage material can be advantageously suppressed. All the heat storage particles used in the heat storage formed article do not necessarily have a particle diameter in the above-mentioned range, and preferably 80% by mass or more of, more preferably 90% by mass or more of, especially preferably 95% by mass or more of the heat storage particles in the heat storage formed article are the heat storage particles having a particle diameter in the above-mentioned range.

In one or more embodiments, the phase change material undergoes a phase change at the melting point thereof which is a specific temperature. Specifically, when the room temperature is higher than the melting point, the phase change material undergoes a phase change from solid to liquid, and, when the room temperature is lower than the melting point, the phase change material undergoes a phase change from liquid to solid. The melting point of the phase change material may be controlled according to the mode of the use thereof, and the phase change material which exhibits solid/liquid phase transition at a temperature in the range of from about −20 to 120° C. can be appropriately used. For example, when the temperature in housing spaces of houses and the like or interior spaces of automobiles, electric trains, aircraft, agricultural hothouses and the like is maintained at an appropriate temperature in an attempt to save energy, appropriate temperature maintaining performance can be exhibited by mixing the phase change material having a melting point designed to a temperature suitable for everyday life, specifically 10 to 35° C., preferably 15 to 30° C. More specifically, in the case of controlling the appropriate temperature maintaining performance in the season of winter or summer, for the purpose of maintaining the heating effect in the winter, the phase change material preferably having a melting point of about 18 to 28° C., more preferably about 18 to 23° C. is mixed, and, for the purpose of suppressing the temperature rise in the summer, the phase change material preferably having a melting point of about 20 to 30° C., more preferably about 25 to 30° C. is mixed. For achieving both effects, two or more types of the phase change materials having different melting points designed may be mixed. When an attempt is made to save energy for the inside of a refrigerator of refrigeration equipment or the like, the phase change material having a melting point of about −10 to 5° C. may be used.

In one or more embodiments, the content of the heat storage material in the organic heat storage layer is preferably 10 to 80% by mass, more preferably 20 to 70% by mass, further preferably 30 to 60% by mass. When the content of the heat storage material is in the above range, excellent heat storage effect and excellent formability can be readily obtained.

### (Coating Liquid)

In one or more embodiments, the coating liquid forming the organic heat storage layer may be prepared by appropriately mixing components according to the resin component and the heat storage material used. For example, when a vinyl chloride resin is used as the thermoplastic resin, a method is preferred in which, using a vinyl sol coating liquid using vinyl chloride resin particles, a heat storage layer is formed by sol casting. By employing the above production method, forming can be made without kneading using a mixer or the like, extrusion, or the like, and thus the heat storage material is unlikely to suffer breakage, so that the heat storage material is unlikely to ooze out of the obtained heat storage formed article. Further, by using the above method, forming at low temperatures is readily made, and therefore breakage of the heat storage material due to heat can be suppressed, and thus the method can be especially preferably used.

In one or more embodiments when a vinyl sol coating liquid is formed using a vinyl chloride resin, the amount of the vinyl chloride resin contained is preferably 10 to 80% by mass, more preferably 20 to 70% by mass, further preferably 30 to 60% by mass, based on the mass of the solids contained in the coating liquid (components other than the solvent). The amount of the plasticizer contained, relative to 100 parts by mass of the thermoplastic resin contained in the resin composition, is preferably 30 to 150 parts by mass, more preferably 30 to 120 parts by mass, further preferably 40 to 100 parts by mass. Further, the amount of the contained heat storage material mixed into the coating liquid is preferably 10 to 80% by mass, more preferably 20 to 70% by mass, further preferably 30 to 60% by mass, based on the mass of the solids contained in the coating liquid.

In the vinyl sol coating liquid of one or more embodiments, an appropriate solvent can be used. As the solvent, the solvent used in the sol casting method for vinyl chloride resin can be appropriately used, and, especially, preferred examples of solvents include ketones, such as diisobutyl ketone and methyl isobutyl ketone, esters, such as butyl acetate, and glycol ethers. These solvents are preferred because they likely slightly swell the resin at room temperature to help dispersion and likely promote melting or gelation of the resin in the heating step. These solvents may be used individually or in combination.

In one or more embodiments, a diluent solvent may be used together with the above solvent. As the diluent solvent, a solvent which does not dissolve the resin and suppresses the swelling properties of the dispersing solvent can be preferably used. As such a diluent solvent, for example, a paraffin hydrocarbon, a naphthene hydrocarbon, an aromatic hydrocarbon, a terpene hydrocarbon, or the like can be used.

In the vinyl sol coating liquid of one or more embodiments, for suppressing decomposition or deterioration, or discoloration caused mainly due to a dehydrochlorination reaction of the vinyl chloride resin, a heat stabilizer is preferably used. As the heat stabilizer, for example, a calcium/zinc stabilizer, anoctyltinstabilizer, a barium/zinc stabilizer, or the like can be used. The amount of the heat stabilizer contained is preferably 0.5 to 10 parts by mass, relative to 100 parts by mass of the vinyl chloride resin.

In one or more embodiments, the vinyl sol coating liquid may appropriately contain, if necessary, as a component other than those mentioned above, an additive, such as a viscosity depressant, a dispersant, or an anti-foaming agent. The amount of each additive contained is preferably 0.5 to 10 parts by mass, relative to 100 parts by mass of the vinyl chloride resin.

In one or more embodiments, the viscosity of the vinyl sol coating liquid during the application may be appropriately controlled according to the desired thickness of the sheet, the application conditions, or the like, but, for easily obtaining excellent application properties, the viscosity of the vinyl sol coating liquid is preferably 1,000 mPa·s or more, more preferably 3,000 mPa·s or more, further preferably 5,000 mPa·s or more. The upper limit of the viscosity is preferably 70,000 mPa·s or less, more preferably 50,000 mPa·s or less, further preferably 30,000 mPa·s or less, especially preferably 25,000 mPa·s or less. The viscosity of the coating liquid can be measured by means of a Brookfield viscometer.

With respect to the heat storage formed article comprising a sol cast film of the vinyl sol coating liquid containing the vinyl chloride resin particles and the heat storage material, a shear or pressure is not applied to the heat storage material during the production of the formed article, and therefore the heat storage material is unlikely to suffer breakage. Thus, despite the use of a resin material, the heat storage material is unlikely to ooze out of the formed article. Furthermore, the heat storage formed article can be easily laminated on another layer or processed.

### [Heat Storage Laminate]

The heat storage laminate of one or more embodiments of the present invention is a heat storage laminate having the above-mentioned inorganic substrate and organic heat storage layer which are laminated on one another. By virtue of having such a construction, the heat storage laminate can achieve excellent flame retardancy despite using the heat storage layer mainly made of an organic material as a heat storage layer.

The heat storage laminate of one or more embodiments of the present invention preferably has a calorific value of 8 MJ/m² or less for 10 minutes, more preferably 8 MJ/m² or less for 20 minutes, as measured in accordance with JIS A5430 annex JA Heat generation test (cone calorimeter method).

The heat storage laminate of one or more embodiments of the present invention can achieve the above-mentioned advantageous flame retardancy also when using an organic heat storage layer such that a calorific value of more than 8 MJ/m² for less than 5 minutes is obtained when the organic heat storage layer in an independent form is subjected to the above-mentioned heat generation test.

In one or more embodiments, the thickness of the organic heat storage layer may be appropriately controlled according to the mode of the use thereof. For example, when applied to walls for a closed space and the like, from the viewpoint of readily obtaining advantageous heat storage effect, the thickness of the organic heat storage layer is preferably 100 μm or more, more preferably 500 μm or more, further preferably 1 mm or more, especially preferably 3 mm or more. With respect to the upper limit of the thickness, there is no particular limitation, but, when the organic heat storage layer is handled in an independent form, for example, when the organic heat storage layer in a sheet form is formed and then put on the inorganic substrate, from the viewpoint of readily obtaining advantageous flexibility and handling properties, the organic heat storage layer is formed with a thickness of preferably 20 mm or less, more preferably 10 mm or less, further preferably 6 mm or less.

The heat storage laminate of one or more embodiments of the present invention can be produced by a method in which a coating liquid forming an organic heat storage layer is directly applied onto an inorganic substrate so that the organic heat storage layer is laminated on the inorganic substrate, a method in which a coating liquid forming an organic heat storage layer is applied onto a support to form an organic heat storage layer in a sheet form, and then the organic heat storage layer is put on an inorganic substrate, or the like.

As a method for applying the coating liquid to a substrate or a support, a coating machine, such as a roll knife coater, a reverse-roll coater, or a comma coater, can be used. Especially, when a vinyl sol coating liquid is used, there can be preferably used a method in which the coating liquid is fed to form a coating film having a predetermined thickness using a doctor knife or the like.

In one or more embodiments, the coating film obtained by applying a coating liquid or charging a coating liquid into a frame in an arbitrary form is gelled or cured by heating or drying to form an organic heat storage layer. In one or more embodiments of the present invention, the heating temperature for heating the coating film is preferably a temperature such that the coating film temperature becomes 150° C. or lower, more preferably 140° C. or lower, further preferably 130° C. or lower, further preferably 120° C. or lower. By adjusting the coating film temperature to the above-mentioned temperature, breakage of the heat storage material due to heat can be advantageously suppressed. The heating time may be appropriately controlled according to the gelation rate or the like, but the heating time may be adjusted to about 10 seconds to 10 minutes. The heating and drying, such as air-drying, may be appropriately employed in combination.

When a solvent is used in the coating liquid, removal of the solvent may be simultaneously performed in the heating step, but it is also preferred that predrying is performed prior to the heating.

When the organic heat storage layer is formed on a support, with respect to the support used, for example, a resin film used as a film for various steps can be preferably used. Examples of the resin films include polyester resin films, such as a polyethylene terephthalate resin film and a polybutylene terephthalate resin film. With respect to the thickness of the resin film, there is no particular limitation, but the resin film having a thickness of about 25 to 100 μm is easy to handle and is readily available.

With respect to the resin film used as a support in one or more embodiments, one having a surface which has been subjected to release treatment can be preferably used. Examples of release treatment agents used in the release treatment include an alkyd resin, an urethane resin, an olefin resin, and a silicone resin.

After the support is peeled off, the resultant organic heat storage layer may be put on the inorganic substrate, or the support may be peeled off after the organic heat storage layer is put on the inorganic substrate. When processing is performed before the lamination, the organic heat storage layer in the state of being laminated on the support can be subjected to processing.

Further, in the heat storage laminate of one or more embodiments of the present invention, it is preferred that, in addition to the above-mentioned inorganic substrate and organic heat storage layer, various types of functional layers are formed, and the functional layer may be used as a support.

With respect to the functional layer formed in the heat storage laminate of one or more embodiments of the present invention, for example, when an incombustible layer, such as incombustible paper or a metal film, is laminated on the heat storage laminate, it is possible to improve the flame retardancy, and the resultant laminate is especially preferably applied to housing spaces. Further, for example, when a thermal diffusion layer or a heat insulating layer is laminated on the heat storage laminate, the resultant laminate can more effectively exhibit heat storage properties. For applying the heat storage laminate to inner walls and the like for housing spaces, a patterned layer or a decorative layer can be formed on the laminate.

As an example of the construction in which incombustible paper is laminated, there can be mentioned a construction in which incombustible paper is laminated on one surface or both surfaces of the organic heat storage layer. With respect to the incombustible paper, there is no particular limitation as long as it has incombustibility, but, for example, paper having applied thereto, impregnated with, or containing therein a flame retardant can be used. Examples of flame retardants include metal hydroxides, such as magnesium hydroxide and aluminum hydroxide, basic compounds, such as phosphates, borates, and sulfamates, and glass fibers.

When the heat storage laminate having a construction in which a thermal diffusion layer is laminated on the heat storage layer is applied to a closed space, such as an interior space, the thermal diffusion layer exhibits an effect that causes the heat inside the interior space to be uniform, and further can disperse the heat from the interior space (e.g., closed spaces, such as housing spaces of houses and the like, interior spaces of automobiles, electric trains, aircraft and the like, the inside of a refrigerator of refrigerator trucks, and the inside of aircraft) to conduct the heat to the heat storage layer with a less thermal resistance. In the heat storage layer, the heat storage particles cause absorption of heat inside the interior space and emission of heat to the interior space, making it possible to control the temperature environment of the interior space to be at an appropriate temperature.

As the thermal diffusion layer, a layer having a thermal conductivity as high as 5 to 400 W/m·K can be preferably used. By virtue of high thermal conductivity, the locally concentrated heat is diffused to be conducted to the heat storage layer, making it possible to improve the thermal efficiency and cause the room temperature to be uniform.

Examples of materials for the thermal diffusion layer include aluminum, copper, iron, and graphite. In one or more embodiments of the present invention, particularly, aluminum can be preferably used. The reason why aluminum is preferred is, for example, that aluminum also exhibits a heat insulating effect due to reflection of radiant heat. Particularly, in a heating apparatus using radiant heat, the heat insulating effect can improve the heating efficiency. As examples of heating apparatuses mainly using radiant heat, there can be mentioned electric floor heating, hot-water type floor heating, and an infrared heater. Also from the viewpoint of preventing disasters, it is possible to improve the flame retardancy performance.

With respect to the form of the thermal diffusion layer of one or more embodiments, an appropriate form of a layer made of a sheet of the above-mentioned material, a deposited layer of the above material, or the like can be used. When aluminum is used as a material for the thermal diffusion layer, for example, a thermal diffusion layer having stretchability, such as an aluminum foil or an aluminum deposited layer, can be preferably used.

With respect to the thickness of the thermal diffusion layer of one or more embodiments, there is no particular limitation, but the thermal diffusion layer preferably has a thickness of about 3 to 500 μm because it is easy to secure advantageous thermal diffusion properties and handling properties.

When the heat storage laminate has a construction in which a heat insulating layer is laminated on the heat storage layer, the heat storage layer effectively performs absorption of heat and emission of heat on the interior space side, so that the appropriate temperature maintaining effect for the interior space can be especially advantageously exhibited. Further, this construction is also effective in preventing the heat in the interior space from flowing out, or reducing the effect of the heat from the outside air. Utilizing a combination of these effects, the heat storage laminate in one or more embodiments of the present invention can suppress a change of the temperature in the interior space to retain the interior space at an appropriate temperature. Further, when an air-conditioning apparatus, such as an air-conditioner or refrigeration equipment, is used, it is possible to reduce the energy consumption of the apparatus. Thus, the heat storage laminate can advantageously contribute to energy savings for interior spaces.

As the heat insulating layer of one or more embodiments, a layer having a thermal conductivity of less than 0.1 W/m·K can be preferably used. The heat insulating layer exhibits an effect such that the heat is prevented from flowing out of the heat storage layer to the outside air and further the effect of the outside air on the temperature is reduced. With respect to the heat insulating layer, there is no particular limitation as long as it can form a layer having a thermal conductivity of less than 0.1 W/m·K, and, for example, a heat insulating sheet, such as a foamed resin sheet, or a resin sheet containing a heat insulating material, or a heat insulating board, such as extrusion method polystyrene, bead method polystyrene, a polyethylene foam, an urethane foam, or a phenol foam, can be appropriately used. Especially, a heat insulating sheet is preferred because it is easy to secure working properties, and a resin sheet containing a heat insulating material is more preferred because the thermal conductivity can be reduced. Further, a foamed sheet is preferred because it is readily available and inexpensive.

When the heat insulating layer is in a sheet form, it is easy to secure working properties, and, especially, it is preferred that a measured value of the heat insulating layer using a cylindrical mandrel flex testing machine (JIS K 5600) is 2 to 32 mm, in terms of a mandrel diameter.

In one or more embodiments, the heat insulating material used in the heat insulating layer improves the heat insulating properties of the heat storage laminate, and examples of heat insulating materials include porous silica, porous acryl, hollow glass beads, vacuum beads, and hollow fibers. As the heat insulating material 5, a known heat insulating material may be used. In one or more embodiments of the present invention, particularly, porous acryl can be preferably used. The particle diameter of the heat insulating material is not limited, but is preferably about 1 to 300 μm.

When a resin sheet containing a heat insulating material is used as the heat insulating layer of one or more embodiments, the heat insulating material is mixed into a resin material as a base and subjected to sheet forming. Examples of resin materials include, as mentioned above, polyvinyl chloride, polyphenylene sulfide, polypropylene, polyethylene, polyester, and an acrylonitrile-butadiene-styrene resin. As polyester, A-PET, PET-G, or the like can be used. Of these, from the viewpoint of low combustibility upon a fire, a vinyl chloride resin having self-extinguishing properties can be preferably used.

As a sheet forming method of one or more embodiments, for example, a vinyl chloride resin, a plasticizer, and a heat insulating material are subjected to sheet forming using a forming machine for extrusion, calendering, or the like.

In one or more embodiments, the content of the heat insulating material in the heat insulating layer is preferably 20% by mass or more, more preferably 20 to 80% by mass, further preferably 30 to 80% by mass, especially preferably 40 to 80% by mass, based on the mass of the heat insulating layer. When the content of the heat insulating material is in the above range, the heat insulating effect can be advantageously exhibited, and the formation of the heat insulating layer is facilitated.

In the heat insulating layer of one or more embodiments, if necessary, an additive, such as a plasticizer or a flame retardant, may be incorporated.

With respect to the thickness of the heat insulating layer of one or more embodiments, there is no particular limitation, but the larger the thickness, the more excellent the heat retaining properties for interior spaces the heat insulating layer exhibits. For securing the stretchability or working properties of the sheet, the thickness of the heat insulating layer is preferably about 50 to 3,000 μm.

The heat storage laminate of one or more embodiments of the present invention is advantageously used mainly in the interior material application for inner walls, ceilings, floors, and the like of buildings, but can be applied to coating materials for sash window frame, and interior trims for vehicles and the like. Further, the heat storage laminate can be used not only in walls, floors, and ceilings of buildings but also in interior spaces of automobiles, electric trains, aircraft and the like. Furthermore, the heat storage laminate can be used as a low-temperature retaining material for refrigeration equipment and the like.

### EXAMPLES

### Preparation Example 1

100 Parts by mass of polyvinyl chloride resin particles having a polymerization degree of 900 (ZEST PQ92, manufactured by Shin Dai-ichi Vinyl Corporation), 60 parts by mass of an epoxy plasticizer (Monocizer W-150, manufactured by DIC Corporation; viscosity: 85 mPa·s; gelation end-point temperature: 121° C.), 3 parts by mass of a heat stabilizer (GLECK ML-538, manufactured by Showa Varnish Co., Ltd.), and, as other additives, 6 parts by mass of a viscosity depressant (viscosity depressant VISCOBYK-5125, manufactured by BYK Japan KK) and 3 parts by mass of a dispersant (Disperplast-1150, manufactured by BYK Japan KK), and 60 parts by mass of a phase change material (Micronal DS5001X, manufactured by BASF AG; particle diameter: 100 to 300 μm; melting point: 26° C.) in the form of microcapsules having a paraffin encapsulated using an outer shell made of a polymethyl methacrylate (PMMA) resin were blended together to prepare a plastisol coating liquid. A calculated value of the HSP distance between the plasticizer and the phase change material used was 8.88, a calculated value of the HSP distance between the plasticizer and the vinyl chloride resin was 4.6, and the viscosity of the coating liquid obtained immediately after the ingredients were blended and intimately mixed with one another was 7,000 mPa·s. Further, an absorption of the plasticizer into 100 parts by mass of the phase change material was 129 parts by mass. The prepared coating liquid was applied onto a PET film by means of a 5 mm applicator, and then subjected to gelation by heating at a dryer temperature of 150° C. for 8 minutes to form an organic heat storage sheet (A) having a thickness of 3 mm.

### Preparation Example 2

An organic heat storage sheet (B) was formed in substantially the same manner as in Preparation Example 1 except that, instead of the epoxy plasticizer used in Preparation Example 1, a polyester plasticizer (Polycizer W-230H, manufactured by DIC Corporation; viscosity: 220 mPa·s; gelation end-point temperature: 136° C.) was used. A calculated value of the HSP distance between the plasticizer and the phase change material used was 11.04, a calculated value of the HSP distance between the plasticizer and the vinyl chloride resin was 6.4, an absorption of the plasticizer into 100 parts by mass of the phase change material used was 117 parts by mass, and the viscosity of the coating liquid was 8,500 mPa·s.

### Preparation Example 3

An organic heat storage sheet (C) was formed in substantially the same manner as in Preparation Example 1 except that, instead of the epoxy plasticizer used in Preparation Example 1, a trimellitic acid plasticizer (Monocizer W-705, manufactured by DIC Corporation; viscosity: 220 mPa·s; gelation end-point temperature: 143° C.) was used. A calculated value of the HSP distance between the plasticizer and the phase change material used was 9.07, a calculated value of the HSP distance between the plasticizer and the vinyl chloride resin was 4.1, an absorption of the plasticizer into 100 parts by mass of the phase change material was 137 parts by mass, and the viscosity of the coating liquid was 8,500 mPa·s.

### Preparation Example 4

An organic heat storage sheet (D) was formed in substantially the same manner as in Preparation Example 1 except that, instead of 60 parts by mass of the phase change material used in Preparation Example 1, 80 parts by mass of a phase change material (Thermo Memory FP-25, manufactured by Mitsubishi Paper Mills Limited; average particle diameter: 50 μm; melting point: 25° C.) in the form of microcapsules having a paraffin encapsulated using an outer shell made of a melamine resin was used. A calculated value of the HSP distance between the plasticizer and the phase change material used was 22.30, an absorption of the plasticizer into 100 parts by mass of the phase change material used was 81 parts by mass, and the viscosity of the coating liquid was 8,000 mPa·s.

### Preparation Example 5

An organic heat storage sheet (E) was formed in substantially the same manner as in Preparation Example 4 except that, instead of the epoxy plasticizer used in Preparation Example 4, a polyester plasticizer (Polycizer W-230H, manufactured by DIC Corporation; viscosity: 220 mPa·s; gelation end-point temperature: 136° C.) was used. A calculated value of the HSP distance between the plasticizer and the phase change material used was 23.20, an absorption of the plasticizer into 100 parts by mass of the phase change material used was 72 parts by mass, and the viscosity of the coating liquid was 12,000 mPa·s.

### Preparation Example 6

An organic heat storage sheet (F) was formed in substantially the same manner as in Preparation Example 4 except that, instead of the epoxy plasticizer used in Preparation Example 4, a benzoic acid plasticizer (Monocizer PB-10, manufactured by DIC Corporation; viscosity: 80 mPa·s; gelation end-point temperature: 100° C. or lower) was used. A calculated value of the HSP distance between the plasticizer and the phase change material used was 17.10, a calculated value of the HSP distance between the plasticizer and the vinyl chloride resin was 1.4, an absorption of the plasticizer into 100 parts by mass of the phase change material used was 96 parts by mass, and the viscosity of the coating liquid was 8,500 mPa·s.

With respect to the coating liquids, the organic heat storage sheets and others prepared in Preparation Examples 1 to 6, the following evaluation was performed. The results of the evaluation are shown in the table below.

### <Conditions for Measurement of a Plasticizer Viscosity>

Measuring apparatus: Brookfield viscometer (“DVM-B type”, manufactured by Tokyo Keiki Co., Ltd.)
Conditions for measurement: temperature: 25° C., No. 2 rotor, 30 rpm

### <Conditions for Measurement of a Coating Liquid Viscosity>

Measuring apparatus: Brookfield viscometer (“BM type”, manufactured by Tokimec Inc.)
Conditions for measurement: temperature: 25° C., No. 4 rotor, 12 rpm

### <HSP Distance>

An HSP distance between the plasticizer and the phase change material used in the Examples and the Comparative Examples, and an HSP distance between the plasticizer and the vinyl chloride were calculated from the formula shown below.

Using a component dispersion term dD, a polar term dP, and a hydrogen bond term dH for the solubility parameter calculated by HSPiP, an HSP distance between a component A and a component B was calculated from the following formula.

HSP Distance=[4(dDA−dDB)²+(dPA−dPB)²+(dHA−dHB)²]^{0.5}

### <Plasticizer Absorption>

An absorption of a plasticizer into a heat storage material was measured by the below-described method in accordance with JIS K5101-13-1. A sample obtained by weighing 1 g of a heat storage material was placed on a glass plate, and a plasticizer was dropwise added to the sample from a burette so that 4 to 5 droplets of the plasticizer were added at a time, and the plasticizer was kneaded into the sample using a palette knife made of steel. This was repeated and the dropwise addition of the plasticizer was continued until a solid mass of the plasticizer and the sample was formed. Thereafter, one droplet of the plasticizer was added at a time and completely kneaded into the mass, and this was repeated, and a point in time when the mass had become a smooth paste was determined as an end point, and the absorption at the end point was taken as an absorption of the plasticizer. The figures shown in the table are indicated in terms of an absorption of the plasticizer into 100 parts by mass of the heat storage material.

### <Test for Evaluation of Heat Storage Properties>

The sheets formed in the Examples and the Comparative Examples were individually cut into a size having a width of 50 mm×a length of 50 mm and the resultant two test specimens were stacked, and a thermocouple was placed between the specimens at the center of the sheet. The ambient temperature in an environmental testing machine was maintained at 35° C. for 2 hours, and then reduced to 5° C. over 50 minutes, and further maintained at 5° C. for one hour. In this instance, a period of time during which the temperature in the sheet was maintained at a temperature of 28 to 20° C. was measured, and an extension of the appropriate temperature maintaining time from the time (800 seconds) for maintaining the ambient temperature at 28 to 20° C. was calculated to evaluate the appropriate temperature maintaining property. The criteria for the evaluation are as shown below.

[symbol] : Maintaining time: +(200 seconds or more)

O: Maintaining time: +(50 to less than 200 seconds)

x: Maintaining time: +(less than 50 seconds)

### <Test for Evaluation of Oozing Out>

The sheets formed in the Examples and the Comparative Examples were individually cut into a size having a width of 50 mm×a length of 50 mm, and oil absorbing paper having the same size was sandwiched between the cut sheets and they were stacked, and the resultant test specimen was pressed under a load of 50 g/cm² in an environment at 40° C. and at 50% RH for 15 hours, and the heat storage material component which oozed out of the sheet was visually evaluated in terms of a stain of the oil absorbing paper. The criteria for the evaluation are as shown below.

O: The paper has no stain.

Δ: The paper is partially stained.

x: The entire paper is stained.

### <Test for Heat Resistance (Heat Loss)>

The sheets formed in the Examples and the Comparative Examples were individually cut into a size having a width of 50 mm×a length of 50 mm, and the cut sheet was allowed to stand in an environment at 80° C. for one week, and then a change in the mass was measured. The criteria for the evaluation are as shown below.

[symbol] : The mass change is less than 10%.

O: The mass change is 10 to less than 15%.

x: The mass change is 15% or more.

TABLE 1

| | Preparation | Preparation | Preparation | Preparation | Preparation | Preparation |
|---|---|---|---|---|---|---|
| | Example 1 | Example 2 | Example 3 | Example 4 | Example 5 | Example 6 |
| Organic heat storage sheet | (A) | (B) | (C) | (D) | (E) | (F) |
| Formed article temperature | 131.6 | 130.6 | 132.9 | 133.1 | 132.1 | 132 |
| upon forming (Highest | | | | | | |
| temperature) [° C.] | | | | | | |
| Heat storage properties | ⊙ | ⊙ | ⊙ | ⊙ | ⊙ | ⊙ |
| Oozing out | ◯ | ◯ | ◯ | ◯ | ◯ | ◯ |
| Heat resistance (80° C., one | ⊙ | ⊙ | ◯ | ⊙ | ⊙ | ⊙ |
| week) | | | | | | |

### Example 1

Using the organic heat storage sheet (A) prepared in Preparation Example 1 as the organic heat storage layer, and using plasterboard (1) (thickness: 9.5 mm; mass reduction ratio measured when the plasterboard is allowed to have a constant mass at 105° C.: 17.5% by mass) as the inorganic substrate, an urethane adhesive (Cemedine UM-700, manufactured by Cemedine Co., Ltd.) was applied at 100 g/m² onto the plasterboard (1), and the organic heat storage sheet (A) was laminated on the plasterboard, and a pressure of 0.1 kgf/m² was applied to the resultant laminate and the laminate was allowed to stand for 24 hours, and then a PET film was peeled off to obtain a heat storage laminate.

### Example 2

A heat storage laminate was obtained in substantially the same manner as in Example 1 except that plasterboard (2) (thickness: 12.5 mm; mass reduction ratio measured when the plasterboard is allowed to have a constant mass at 105° C.: 17.9% by mass) was used as the inorganic substrate.

### Example 3

A heat storage laminate was obtained in substantially the same manner as in Example 1 except that a calcium silicate board (1) (thickness: 12.0 mm; mass reduction ratio measured when the calcium silicate board is allowed to have a constant mass at 105° C.: 4.4% by mass) was used as the inorganic substrate.

### Example 4

A heat storage laminate was obtained in substantially the same manner as in Example 1 except that a fiber-reinforced cement board (1) (thickness: 9.0 mm; mass reduction ratio measured when the fiber-reinforced cement board is allowed to have a constant mass at 105° C.: 4.7% by mass) was used as the inorganic substrate.

### Example 5

A heat storage laminate was obtained in substantially the same manner as in Example 1 except that the organic heat storage sheet (B) prepared in Preparation Example 2 was used as the organic heat storage layer.

### Example 6

A heat storage laminate was obtained in substantially the same manner as in Example 1 except that the organic heat storage sheet (C) prepared in Preparation Example 3 was used as the organic heat storage layer.

### Example 7

A heat storage laminate was obtained in substantially the same manner as in Example 1 except that the organic heat storage sheet (D) prepared in Preparation Example 4 was used as the organic heat storage layer.

### Example 8

A heat storage laminate was obtained in substantially the same manner as in Example 1 except that the organic heat storage sheet (E) prepared in Preparation Example 5 was used as the organic heat storage layer.

### Example 9

A heat storage laminate was obtained in substantially the same manner as in Example 1 except that the organic heat storage sheet (F) prepared in Preparation Example 6 was used as the organic heat storage layer.

### Comparative Example 1

A laminate was obtained in substantially the same manner as in Example 1 except that plasterboard (3) (thickness: 9.5 mm; mass reduction ratio measured when the plasterboard is allowed to have a constant mass at 105° C.: 0% by mass) was used as the inorganic substrate.

### Comparative Example 2

A laminate was obtained in substantially the same manner as in Example 1 except that a calcium silicate board (2) (thickness: 6.0 mm; mass reduction ratio measured when the calcium silicate board is allowed to have a constant mass at 105° C.: 2.9% by mass) was used as the inorganic substrate.

### Comparative Example 3

A laminate was obtained in substantially the same manner as in Example 1 except that a magnesium oxide board having a glass fiber net (1) (thickness: 6.0 mm; mass reduction ratio measured when the magnesium oxide board is allowed to have a constant mass at 105° C.: 11.5% by mass) was used as the inorganic substrate.

With respect to the laminates and the like obtained in the above Examples and Comparative Examples, the following evaluation was performed. The results of the evaluation are shown in the tables below.

### <Measurement of a Mass Reduction Ratio of an Inorganic Substrate>

An inorganic substrate was cut into a size of 99 mm×99 mm, and, in accordance with the drying loss method of JIS K-0068, a mass (w₁) of the inorganic substrate before being dried and a mass (w₂) of the specimen of the inorganic substrate which was dried by heating at a temperature of 105° C. so as to have a constant mass were measured, and a mass reduction ratio was calculated from the formula shown below. With respect to the inorganic substrates other than the plasterboard (3), before being dried, each inorganic substrate was placed in an environment at a temperature of 23° C. and at a humidity of 50% so as to have a constant mass, and the obtained mass was used as a mass of the inorganic substrate before being dried.

Mass reduction ratio (% by mass)=[(w₁−w₂)/w₁]×100

### <Heat Generation Test>

The laminates obtained in the Examples and the Comparative Examples were individually cut into a size of 99 mm×99 mm to prepare a specimen. Using the specimen, a heat generation test was conducted in accordance with JIS A5430 annex JA Heat generation test (cone calorimeter method). The criteria for the evaluation are as shown below.

### (Gross Calorific Value)

[symbol] : The gross calorific value is not more than 8.0 MJ/m² for 20 minutes.

O: to [symbol] : A period of time during which the gross calorific value is not more than 8.0 MJ/m² is more than 15 to 20 minutes.

O: A period of time during which the gross calorific value is not more than 8.0 MJ/m² is more than 10 to 15 minutes.

x: The gross calorific value exceeds 8.0 MJ/m² in 10 minutes or less.

Further, with respect to a specimen such that a period of time during which the gross calorific value is not more than 8.0 MJ/m² is more than 10 minutes, at a point in time when 10 minutes lapsed, the external appearance of the specimen was evaluated in accordance with the criteria shown below.

### (Evaluation of Appearance)

O: A crack or hole which penetrates the back surface is not found.

x: A crack or hole which penetrates the back surface occurs.

TABLE 2

| | | Example 1 | Example 2 | Example 3 | Example 4 | Example 5 | Example 6 | Example 7 | Example 8 | Example 9 |
|---|---|---|---|---|---|---|---|---|---|---|
| Organic heat storage | | (A) | (A) | (A) | (A) | (B) | (C) | (D) | (E) | (F) |
| sheet | | | | | | | | | | |
| Inorganic | Mass | 17.5 | 17.9 | 4.4 | 4.7 | 17.5 | 17.5 | 17.5 | 17.5 | 17.5 |
| substrate | reduction | | | | | | | | | |
| | ratio | | | | | | | | | |
| | [mass %] | | | | | | | | | |
| | Thickness | 9.5 | 12.5 | 12 | 9 | 9.5 | 9.5 | 9.5 | 9.5 | 9.5 |
| | [mm] | | | | | | | | | |
| Heat | Gross | ◯ to ⊙ | ⊙ | ◯ | ◯ | ◯ to ⊙ | ◯ to ⊙ | ◯ to ⊙ | ◯ to ⊙ | ◯ to ⊙ |
| generation | calorific | | | | | | | | | |
| test | value | | | | | | | | | |
| | Evaluation | ◯ | ◯ | ◯ | ◯ | ◯ | ◯ | ◯ | ◯ | ◯ |
| | of | | | | | | | | | |
| | appearance | | | | | | | | | |

TABLE 3

| | | Compar- | Compar- | Compar- | |
|---|---|---|---|---|---|
| | | ative | ative | ative | Reference |
| | | Example 1 | Example 2 | Example 3 | Example 1 |
| Organic heat storage | | (A) | (A) | (A) | (A) |
| sheet | | | | | |
| Inorganic | Mass | 0 | 2.9 | 11.5 | None |
| substrate | reduction | | | | |
| | ratio | | | | |
| | [mass %] | | | | |
| | Thickness | 9.5 | 6 | 6 | |
| | [mm] | | | | |
| Heat | Gross | X | X | X | X |
| generation | calorific | | | | |
| test | value | | | | |
| | Evaluation | — | — | — | — |
| | of | | | | |
| | appearance | | | | |

As apparent from the above tables, the heat storage laminates of one or more embodiments of the present invention in Examples 1 to 9 were able to achieve advantageous flame retardancy despite using the organic heat storage layer having excellent heat storage performance. On the other hand, the laminates in Comparative Examples 1 to 3 had poor flame retardancy. The sample in Reference Example 1 having no inorganic substrate laminated ignited in 14 seconds.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A heat storage laminate, comprising:
an inorganic substrate; and
an organic heat storage layer,
wherein the inorganic substrate and the organic heat storage layer are laminated to one another,
wherein the inorganic substrate has a thickness of 8 mm or more, and
wherein the inorganic substrate has amass reduction ratio of 4% by mass or more, as measured when the inorganic substrate is held at a temperature of 105° C. until a constant mass is obtained.

2. The heat storage laminate according to claim 1, wherein the inorganic substrate has a water vapor permeability (water vapor permeation coefficient per unit thickness) of 100 ng/m·s·Pa or less, as measured in accordance with JIS A1324 Cup method.

3. The heat storage laminate according to claim 1, wherein the inorganic substrate has a thermal conductivity of 3 W/m·K or less, as measured in accordance with JIS A1412-2.

4. The heat storage laminate according to claim 1, wherein the organic heat storage layer comprises a resin matrix and a heat storage material that is dispersed in the resin matrix.

5. The heat storage laminate according to claim 4, wherein the resin matrix is a resin composition comprising a thermoplastic resin and a plasticizer.

6. The heat storage laminate according to claim 5, wherein, when the heat storage material and the plasticizer are mixed, 100 parts by mass of the heat storage material absorbs 150 parts by mass or less of the plasticizer.

7. The heat storage laminate according to claim 4, wherein the heat storage material is a plurality of microcapsules,
wherein each of the microcapsules comprises a resin outer shell and a phase change material that is contained within the resin outer shell.

8. The heat storage laminate according to claim 1, further comprising incombustible paper laminated thereto.

9. The heat storage laminate according to claim 1, further comprising at least one of a thermal diffusion layer or a heat insulating layer laminated thereto.
